(19) United States
(12) Patent Application Publication
(10) Pub. No.: US 2001/0054077 A1
(43) Pub. Date: Dec. 20, 2001

(54) Electronic mail delivery apparatus and method thereof

(76) Inventor: Akira Usami, Chiba (JP)

Correspondence Address: BIRCH STEWART KOLASCH & BIRCH, PO BOX 747, FALLS CHURCH, VA, 22040-0747, US

(21) Appl. No.: 09/883,177

(22) Filed: Jun. 19, 2001

(30) Foreign Application Priority Data
Jun. 19, 2000 (JP) 2000-182796

(51) Int. Cl. G06F 15/16

(52) U.S. Cl. 709/206; 709/245

(57) ABSTRACT

An e-mail delivery apparatus enabling a user sending e-mail to designate a time the e-mail is delivered to a user to whom the e-mail is sent, including a receiving unit for receiving e-mail and transmission time information designating the time the e-mail is to be sent to the mail destination, a memory for storing the received e-mail and the transmission time information, and a transmission unit for reading the e-mail stored in the memory means based on the transmission time information and sending information in accordance with the read e-mail to the mail destination.

### BACKGROUND OF THE INVENTION

1. Field of the Invention

The present invention relates to an electronic mail delivery apparatus for delivering electronic mail, for example, by using the Internet, and a method thereof.

2. Description of the Related Art

Electronic mail (hereinafter simply referred to as “e-mail”) delivery services for delivering e-mail by using the Internet etc. are currently spreading widely.

In e-mail delivery services of the related art, for example, a user operates a terminal such as a personal computer to send e-mail including user ID information specifying the user to a server providing an e-mail delivery service via the Internet. The server stores the e-mail received from the sending terminal and sends it to a terminal of a destination user, for example, when accessed by the destination user from the terminal of that user.

In the above e-mail delivery service, when e-mail is received from a sending terminal, the server sends the e-mail to the terminal of the destination user immediately when accessed by the destination user from another terminal.

There is, however, a demand for a service where a user can send itself e-mail written at the present time to be received on a predetermined date after several years, for example, like writing a letter to itself in the future.

Also, there is a demand for a service where a user can send e-mail to another person to be received by that person at a predetermined date and time.

In the above e-mail delivery services of the related art, however, a user who sends e-mail cannot specify the date and time that the designated user receives the e-mail, so the above demands cannot be met.

### SUMMARY OF THE INVENTION

An object of the present invention is to provide an e-mail delivery apparatus and method enabling a sender to designate the time that a receiver receives an e-mail.

To solve the disadvantage of the related art and attain the above object, according to a first aspect of the present invention, there is provided an e-mail delivery apparatus comprising a receiving means for receiving e-mail and transmission time information designating a time the e-mail is to be sent to the mail destination; a memory means for storing the received e-mail and the transmission time information; and a transmission means for reading e-mail stored in the memory means based on the transmission time information and sending information in accordance with the read e-mail to the mail destination; wherein the transmission means inquires at the mail destination whether or not it desires to receive the information in accordance with the e-mail before the time designated by the transmission time information and, when receiving a response that it desires to receive the information in accordance with the e-mail from the mail destination, sends the information in accordance with the e-mail to the mail destination.

The mode of operation of the e-mail delivery apparatus of the present invention is explained below.

First, the receiving means receives from a sending user the e-mail and transmission time information designating a time for sending the e-mail to a mail destination.

Next, the received e-mail and the transmission time information are stored in the memory means.

Next, the transmission means inquires at the mail destination whether or not it desires to receive information in accordance with the e-mail before the time designated by the transmission time information.

When the receiving means receives a response that it desires to receive the information in accordance with the e-mail, the transmission means sends the information in accordance with the e-mail to the mail destination.

According to a second aspect of the present invention, there is provided a method of e-mail delivery including the steps of sending e-mail and transmission time information designating a time the e-mail is to be sent to a mail destination from a terminal to an e-mail delivery apparatus; inquiring from the e-mail delivery apparatus to the terminal whether or not the terminal desires to receive the information in accordance with the e-mail before a time specified by the transmission time information; and sending the information in accordance with the e-mail from the e-mail delivery apparatus to the terminal when the e-mail delivery apparatus receives a response that it desires to receive the information in accordance with the e-mail from the terminal.

### BRIEF DESCRIPTION OF THE DRAWINGS

These and other objects and features of the present invention will become clearer from the following description of the preferred embodiments given with reference to the accompanying drawings, in which:

FIG. 1 is a view of the configuration of an e-mail delivery system according to an embodiment of the present invention;

FIG. 2 is a view of the configuration of a server as shown in FIG. 1;

FIG. 3 is a view of the configuration of a receiving unit shown in FIG. 2;

FIG. 4 is a view of the configuration of a memory shown in FIG. 2;

FIG. 5 is a view of the configuration of a transmission unit shown in FIG. 2; and

FIG. 6 is a flow chart for explaining an example of the operation of the e-mail delivery system shown in FIG.

### DESCRIPTION OF THE PREFERRED EMBODIMENTS

Below, an e-mail delivery system according to an embodiment of the present invention will be explained.

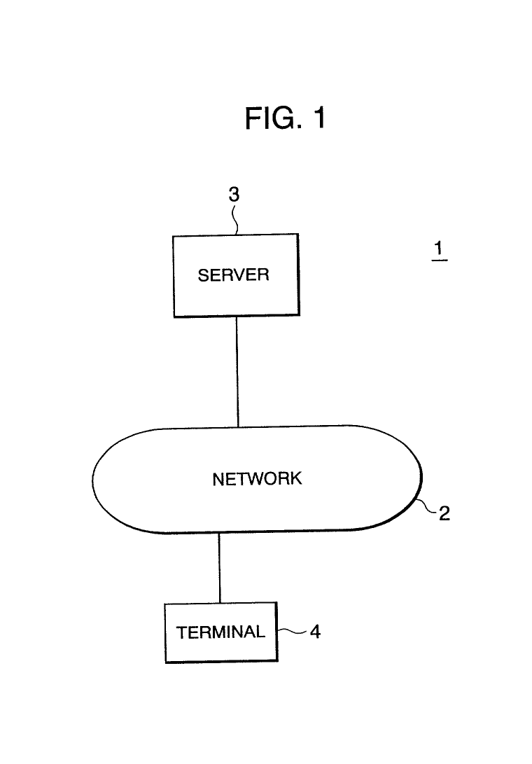

FIG. 1 is a view of the configuration of an e-mail delivery system 1 of the present embodiment.

As shown in FIG. 1, in the e-mail delivery system 1, for example, a server 3 and a terminal 4 are connected via a network 2.

Note that in the example shown in FIG. 1, a single terminal is illustrated, but a plurality of terminals are actually used.

Here, the server 3 corresponds to the e-mail delivery apparatus of the present invention, while the terminal 4 corresponds to the terminal of the present invention.

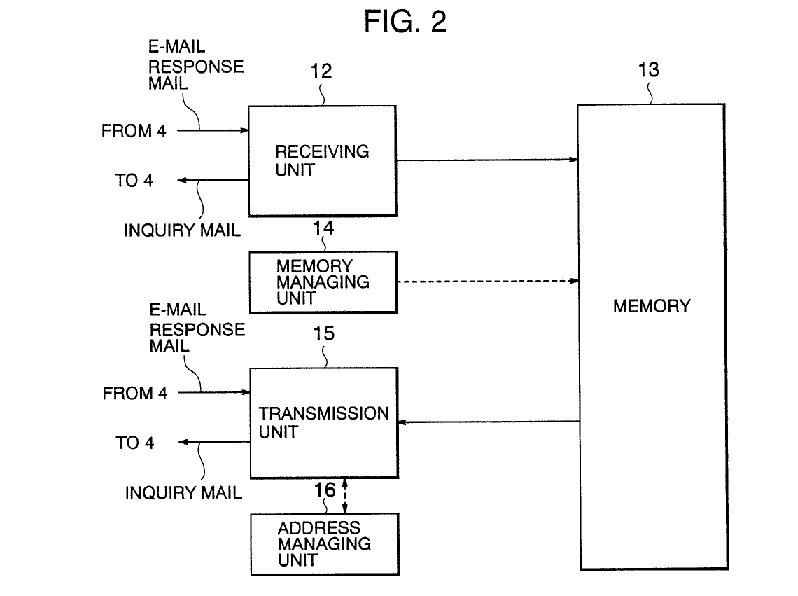

FIG. 2 is a view of the configuration of the server 3 shown in FIG. 1.

As shown in FIG. 2, the server 3 comprises a receiving unit 12, memory 13, memory management unit 14, transmission unit 15, and address management unit 16.

Here, the receiving unit corresponds to a receiving means of the present invention, the memory 13 corresponds to a memory means of the present invention, the transmission unit 15 corresponds to a transmission means of the present invention, and the address management unit 16 corresponds to an address management means of the present invention.

Below, the components of the server 3 shown in FIG. 2 will be explained in detail.

[Receiving Unit 12]

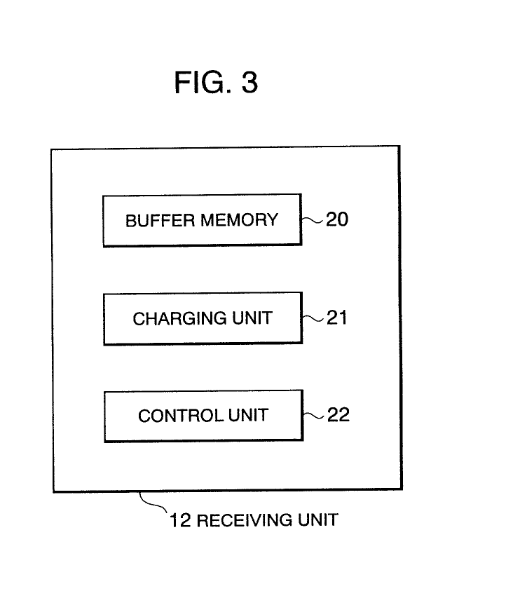

FIG. 3 is a view of the configuration of the receiving unit 12.

As shown in FIG. 3, the receiving unit 12 comprises a buffer memory 20, charging unit 21, and control unit 22.

The buffer memory 20 temporarily stores e-mail received from the terminal 4 via the network 2 shown in FIG. 1.

The charging unit 21 performs predetermined charging processing, for example, at the time of receiving the e-mail, based on charging information received from the terminal 4. As the charging processing, for example, there are charging processing on the user who sent the e-mail and charging processing on a sponsor of the e-mail delivery service such as an advertiser.

The charging information includes information for settling an account such as an account number of a net bank etc., credit card number, account number of electronic money, prepaid account number, passwords, and other ID verification information encoded in a predetermined format. The charging unit 21 notifies a charging amount etc. to the terminal 4. Furthermore, the charging unit 21 performs the charging processing while communicating with a not illustrated account settlement system. Note that in the charging processing by the charging unit 21, for example, predetermined points may be given to the user in accordance with the state of its use of the service and the charge discounted in accordance with the accumulated points.

When storing received e-mail in the buffer memory 20, the control unit 22, for example, sends to the terminal 4 inquiry mail asking for necessary information for storing and sending the e-mail via the network 2.

The inquiry mail is e-mail asking for transmission time information for determining the transmission time of the e-mail by the server 3, information for address management necessary for managing an address of the mail destination of the e-mail by the server 3, information for charging necessary for charging, etc.

Here, for example, as the transmission time information, the desired storage time of e-mail etc. are used. As the address management information, for example, user ID information etc. of the destination user of the e-mail transmission at the present time are used. As the charging information, for example, account information of a net bank which settles the account etc. are used.

[Memory 13]

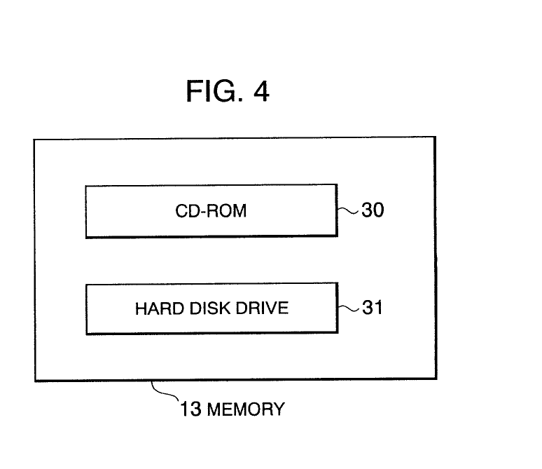

FIG. 4 is a view of the configuration of the memory 13.

As shown in FIG. 4, the memory 13 comprises, for example, a CD-ROM 30 and a hard disk drive 31.

The CD-ROM 30 stores e-mail desired to be stored for a predetermined time or more among e-mail received by the receiving unit 12.

The hard disk 31 stores e-mail whose transmission time is approaching by a predetermined time.

Note that the CD-ROM 30 may be permanently mounted in a reading apparatus or may be kept in a different place and attached to the reading apparatus by a manager in accordance with need. The type of storage medium is not particularly limited in the present invention, however.

[Memory Management Unit 14]

The memory management unit 14 manages storage of information of the e-mail etc. in the memory 13.

For example, the memory management unit 14 monitors a transmission time of e-mail stored in the CD-ROM 30 of the memory 13 shown in FIG. 4 based on the transmission time information and transfers the e-mail from the CR-ROM 30 to the hard disk 31 when a predetermined time before the transmission time is reached.

When storing e-mail for a long period, the memory management unit 14 manages storage to store the e-mail in as low cost a storage medium as possible without hindering smooth service.

[Transmission Unit 15]

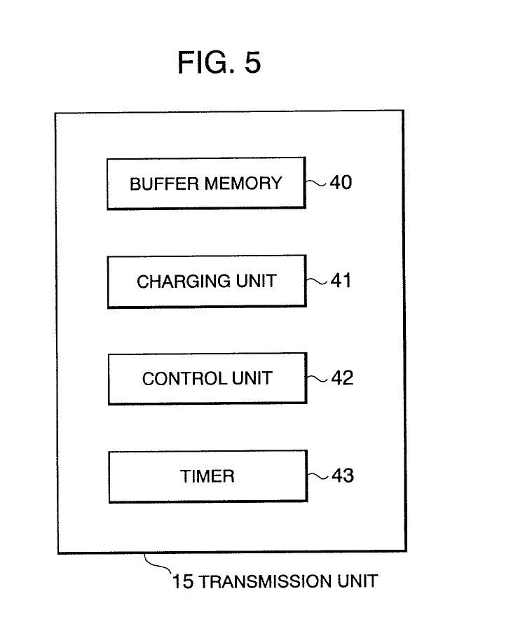

FIG. 5 is a view of the transmission unit 15.

As shown in FIG. 5, the transmission unit 15 comprises a buffer memory 40, charging unit 41, control unit 42, and timer 43.

The buffer memory 40 transfers and stores e-mail to be sent within a predetermined time in accordance with the transmission from the hard disk 31 shown in FIG. 4.

The charging unit 41 performs predetermined charging processing at the time of sending the e-mail to the terminal 4. For example, the charging unit 41 performs charging processing for charging a predetermined fee to the user of the terminal 4. In this case, for example, the user of the terminal 4 may determine the payment fee for receiving the e-mail in a range of more than a certain amount of money.

When the control unit 42 judges that the time indicated by the timer 43 has reached the time indicated by the transmission time information obtained at the time of receiving the e-mail by the receiving unit 12, the control unit 42 sends inquiry mail to the mail destination of the e-mail based on the address information obtained from the address management unit 16. Note that the timing for sending the inquiry mail is not particularly limited so far as it is before the transmission time designated by the transmission time information.

The inquiry mail includes information asking about a desire to receive the e-mail and information necessary for charging.

The control unit 42, when receiving a response mail to the inquiry mail, judges the content of the response mail. When reception is desired and necessary charging information is included, the control unit 42 sends the corresponding e-mail stored in the buffer memory 40 to the terminal 4 via the network 2.

On the other hand, when the response mail indicates that reception is not desired, the control unit 42 discards the e-mail stored in the buffer memory 40.

[Address Management Unit 16]

When receiving, for example, a notice of change of address in response to an operation of the terminal 4 by the destination user of the e-mail transmission, the address management unit 16 updates the address of the mail destination indicated by the address information corresponding to the user.

The address information is used for determining the address of the mail destination at the time that the control unit 42 of the transmission unit 15 sends an inquiry e-mail and e-mail as explained above.

As an address management method by the address management unit 16, a variety of methods can be considered. It may consist, for example, of issuing a password for verification of ID to a user, receiving information of the password and information of a set of an old address and new address from the user, writing a new address of an address library using the old address as a key after checking the password, and preparing a new library using the new address as a key. In this case, an address is determined as final when a search using the old address as a key fails to turn up a new address.

Also, the address management unit 16 may manage for example personal information of users (name, age, sex, occupation, telephone number, facsimile number, address, etc. of users) other than managing addresses.

Below, an example of the operation of the e-mail delivery system 1 shown in FIG. 1 will be explained.

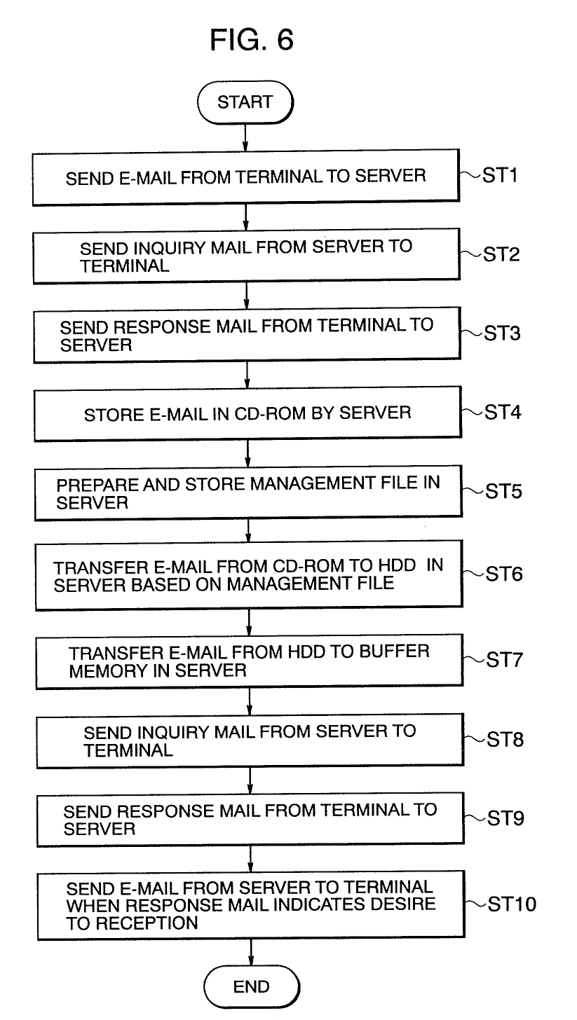

FIG. 6 is a flow chart for explaining the example of the operation.

Step ST1: A request for service made by a user desiring to use the e-mail delivery service of the server 3 is sent together with the e-mail to be delivered from the terminal 4 shown in FIG. 1 to the server 3 via the network 2.

The e-mail is received by the receiving unit 12 of the server 3 shown in FIG. 2 and stored in the buffer memory 20 in the receiving unit 12 shown in FIG. 3.

Step ST2: The control unit 22 of the receiving unit 12 shown in FIG. 3 sends inquiry mail inquiring about delivery time information, charging information, and address management information to the terminal 4 via the network 2.

Step ST3: When the terminal 4 receives the inquiry mail, it displays the content of the inquiry mail on a display.

The user operates an operation means while viewing the display and inputs information required by the inquiry mail to the terminal 4.

The terminal 4 sends response mail including the information input by the user in response to the inquiry mail to the server 3 via the network 2.

Step ST4: The control unit 22 shown in FIG. 3 of the receiving unit 12 of the server 3 stores the information included in the response mail received from the terminal 4 with the corresponding e-mail stored in the buffer memory 20 under management by the memory control unit 14 shown in FIG. 2. The e-mail is usually stored in a CD-ROM 30 in the memory 13 shown in FIG. 4.

At this time, the charging unit 21 shown in FIG. 3 uses the information necessary for charging received from the terminal 4 at step ST3 to, for example, store the e-mail and perform charging processing of the delivery service.

Step ST5: The memory management unit 14, for example, prepares a management file for managing a transmission date and time of the e-mail from the information included in the response mail received by the receiving unit 12 at step ST4 and stores the same in the memory 13 or in an internal memory of the memory management unit 14.

Step ST6: The memory management unit 14 transfers the e-mail from the CD-ROM 30 to the hard disk 31, for example, when the transmission time approaches by a predetermined time based on the management file.

Step ST7: The control unit 42 in the transmission unit 15 in FIG. 5 of the server 3 shown in FIG. 2 transfers the e-mail a predetermined time before the transmission time from the hard disk 31 of the memory 13 shown in FIG. 4 to the buffer memory 40 in the transmission unit 15 in FIG. 5 based on the time indicated by the timer 43 and the management file or the above transmission time information.

Step ST8: When the control unit 42 of the transmission unit 15 judges that the time indicated by the timer 43 has reached the transmission time of the e-mail, it sends inquiry mail to the address to which the e-mail is to be sent designated by the address management information managed by the address management unit 16 via the network 2.

The inquiry mail asks about the desire for receiving the e-mail, information necessary for charging, etc.

Step ST9: When the terminal 4 receives the inquiry mail, it displays the content of the inquiry mail on the display.

The user operates the operation means while viewing the display to input information required by the inquiry mail to the terminal 4.

The terminal 4 sends response mail including the information input by the user in response to the inquiry mail to the server 3 via the network,2.

Step ST10: When the control unit 42 of the transmission unit 15 receives response mail to the inquiry mail from the corresponding terminal 4, it judges the content of the response mail. When the terminal desires reception and information necessary for charging is included therein, the control unit 42 sends the corresponding e-mail stored in the buffer memory 40 to the terminal 4 via the network 2.

On the other hand, when the response mail indicates the terminal does not desire to receive the e-mail, the control unit 42 discards the e-mail stored in the buffer memory 40.

As explained above, according to the e-mail delivery system 1, a user can make use of a service enabling it to send itself or another person e-mail sent at a desired date and time.

Also, according to the e-mail delivery system 1, since the latest address of a destination user is always known, the e-mail can be suitably delivered to the user even if the address of the user is changed.

The present invention is not limited to the above embodiment.

For example, in the above embodiment, the case where e-mail sent by the terminal 4 shown in FIG. 1 was sent again to the terminal 4 by the server 3 was explained as an example, but the terminal the e-mail is to be sent to may be another terminal other than the terminal 4 as well.

Also, in the present invention, the user receiving the e-mail may be the same person as the user sending the e-mail or a different person.

Also, in the above embodiment, a case of sending e-mail to a mail destination was explained as an example, but information in accordance with the received e-mail may also be sent to the mail destination by a facsimile, telephone, snail mail, etc.

Also, in the above embodiment, a case where charging processing was performed at the time of both receiving e-mail and sending e-mail was explained as an example, but it is also possible to perform this processing only on one side.

Summarizing the effects of the invention, as explained above, according to the present invention, an e-mail delivery apparatus and method capable of designating the time a destination user of e-mail receives the e-mail can be provided.

Note that the present invention is not limited to the above embodiments and includes modifications within the scope of the claims.

What is claimed is:

1. An e-mail delivery apparatus comprising:
a receiving means for receiving e-mail and transmission time information designating a time the e-mail is to be sent to the mail destination;
a memory means for storing the received e-mail and the transmission time information; and
a transmission means for reading e-mail stored in the memory means based on the transmission time information and sending information in accordance with the read e-mail to the mail destination; wherein
said transmission means inquires at the mail destination whether or not it desires to receive the information in accordance with the e-mail before the time designated by the transmission time information and, when receiving a response that it desires to receive the information in accordance with the e-mail from the mail destination, sends the information in accordance with the e-mail to the mail destination.

2. An e-mail delivery apparatus as set forth in claim 1, wherein said receiving means inquires to a transmitter of said e-mail about a time for sending said e-mail when receiving said e-mail and receives said transmission time information in accordance with the inquiry.

3. An e-mail delivery apparatus as set forth in claim 1, wherein
said receiving means receives address management information of the mail destination of said e-mail and charging information; and
said e-mail delivery apparatus further comprises an address management means for managing an address of the mail destination of information in accordance with said e-mail based on said address management information and a charging means for performing charging based on said charging information.

4. An e-mail delivery apparatus as set forth in claim 3, wherein said charging means performs at least one of charging processing to the transmitter of the e-mail at the time of receiving said e-mail and charging processing to the mail destination at the time of sending the information in accordance with said e-mail.

5. An e-mail delivery apparatus as set forth in claim 3, wherein, when a notice of change of address of the mail destination of said e-mail is received, said address management means sends the information in accordance with said e-mail to the changed address.

6. An e-mail delivery apparatus as set forth in any one of claims 1, wherein said transmission means sends the information in accordance with said e-mail to said mail destination in at least one form of e-mail, facsimile, telephone, and snail mail.

7. A method of e-mail delivery including the steps of
sending e-mail and transmission time information designating a time the e-mail is to be sent to a mail destination from a terminal to an e-mail delivery apparatus;
inquiring from the e-mail delivery apparatus to the terminal whether or not the terminal desires to receive the information in accordance with the e-mail before a time specified by the transmission time information; and
sending the information in accordance with the e-mail from the e-mail delivery apparatus to the terminal when the e-mail delivery apparatus receives a response that it desires to receive the information in accordance with the e-mail from the terminal.
